(19) United States
(12) Patent Application Publication
(10) Pub. No.: US 2016/0207764 A1
(43) Pub. Date: Jul. 21, 2016

(54) Novel Methods for Storing Hydrogen in PFC Solutions

(71) Applicant: Demetrios Markou, Lemont, IL (US)

(72) Inventor: Demetrios Markou, Lemont, IL (US)

(21) Appl. No.: 15/003,599

(22) Filed: Jan. 21, 2016

Related U.S. Application Data
(60) Provisional application No. 62/106,153, filed on Jan. 21, 2015.

(51) Int. Cl. C01B 3/00; C07C 7/20

(52) U.S. Cl. CPC C01B 3/0015; C07C 7/20

(57) ABSTRACT

This invention describes novel methods for using solid and liquid perfluorinated solutions for hydrogen storage devices.

### CROSS-REFERENCE TO RELATED APPLICATIONS

This application claims priority from an earlier filed U.S. Provisional Application, entitled Novel Methods for Storing Hydrogen in PFC Solutions, U.S. Application No. 62/106,153 filed on Jan. 21, 2015.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable.

### REFERENCE TO A COMPACT DISC

Not Applicable.

### BACKGROUND OF THE INVENTION

### Properties of Fluorocarbons

Perfluorocarbon (PFC) liquids dissolve large volumes of gasses. It is known that PFCs are linear, cyclic, or polycyclic hydrocarbons in which hydrogen atoms have been substituted with fluorine. Liquid PFCs are colorless, odorless, and have specific gravities about twice that of water. PFCs are hydrophobic and do not dissociate in aqueous media.

PFCs were originally produced commercially during World War II as part of the Manhattan Project, in the search for an inert resilient handling material that could resist the corrosion of reactive uranium isotopes being synthesized for the first atomic bomb. PFCs owe their extreme inertness to the carbon-fluorine bond, which is known to be one of the strongest bonds in organic chemistry. The protective effects of PFCs, in general, come from the electron-rich fluorine atoms lying on the carbon backbone of the molecule.

Typically, it takes extreme temps above 400° C. to see any type of degradation in highly fluorinated fluorocarbons.

Commercial applications of PFCs include their use as, blood substitutes, industrial lubricants, lasers, coolants, and anti-corrosion agents, such as Teflon, the solid protective anti-stick coating on household cookware.

PFCs have one of the highest gas solubility and carrying capacities of known liquids. The solubility of the gas in a PFC liquid at a given temperature is directly proportional to the partial pressure of the gas dissolved within the solution, obeying Henry's Law.

### BRIEF SUMMARY OF THE INVENTION

Perfluorocarbons (PFC's) have the ability to absorb large amounts of gas relative to their given volume and have the ability to store hydrogen and hydrocarbon gasses both at Standard Temperature and Pressure (STP) and above STP; in which PFCs can will be used as a medium to store hydrogen or hydrocarbon gases to power systems like fuel cells and or for internal or external combustion applications.

Aspects of this invention relates to the powering of a power system by diffusing hydrogen through a fluorocarbon liquid where the solution is static or circulated through a fuel cell. Other aspects include hydrogen or hydrocarbon gasses stored inside a PFC nano porous scaffolding structure within a pressure vessel.

This invention describes three embodiments to achieve these results. Those are:

1. The use of a relatively low molecular weight PFC liquid solution that is used within fuel cells to temporally store hydrogen, at STP, and or above STP. Hydrogen is directly injected into the PFC solution liquid stream in a static closed system or in a closed re-circulating system. By passing the PFC solution through a heat exchanger, heat is exchanged to the surroundings. It is also anticipated that a refrigeration cycle may be utilized, where the PFC solution is the refrigerant. The PFC solution is then compressed and then evaporated for a cooling refrigeration cycle and hydrogen is injected in line after the PFC solution is compressed back to a liquid. More specifically, this invention relates to a closed hydrogen storage system, where hydrogen can be injected or bubbled into a liquid PFC stream, where the hydrogen is stored temporally within the solution itself, while hydrogen diffuses through the solution to power the fuel cell system.

2. The use of nano confined scaffolding material within a relatively low molecular weight liquid PFC solution to store hydrogen and hydrocarbon gasses under pressure. The scaffolding materials that can be used are but are not limited to metallic scaffolds, Silicon aero gels, organic frameworks, mesoporous frameworks like MCM-41, metal hydrides, carbon derivatives, like fullerenes, nano tubes, Graphene, Graphene oxides. The ratio of the scaffolding material is anticipated to be 0 to 99%.

3. The use of a solid state PFC solution, such as but not limited to C4Cl4F4 to be used within pressure vessels to store hydrogen and its derivative gasses under pressure, with a 0% to 99% mixture of nano porous scaffolding material. The scaffolding materials that can be used are but are not limited to metallic scaffolds, Silicon aero gels, organic frameworks, mesoporous frameworks like MCM-41, metal hydrides, carbon derivatives, like fullerenes, nano tubes, Graphene, Graphene oxides. The ratio of the scaffolding material is anticipated to be 0 to 99%. This solid state design eliminates any possibility for PFC gases to escape to the atmosphere.

In this invention, the solution comprises a relatively low molecular weight PFC solution wherein the PFC solution is in a liquid or is in a solid state form. The PFC solution desired should have a low molecular weight, with a low fluoride to carbon bond ratio and is used to store hydrogen or other hydrogen based gases at STP or above STP. When using a low molecular weight PFC solution within hydrogen fuel cells, the solution can be circulated, and hydrogen can be injected in stream to charge the solution, or hydrogen can be bubbled within a static solution to charge it. One object of this invention is that the solution can be passed through a heat exchanger prior to hydrogen injection. Another object is that we can maintain a refrigeration cycle, were hydrogen is injected in stream once the PFC solution is compressed back into a liquid state. Hydrogen can also be bubbled or diffused within the solution as well without circulating the solution, or engaged in a cooling or refrigeration cycle. It is anticipated that this is a completely closed system, with none of the PFC solution to being emitted to the atmosphere. The PFC solution acts as a medium in fuel cell applications; in this arrangement, the PFC solution acts like a battery to temporarily store hydrogen in the PFC fluid, also by circulating the fluid, the PFC can be cooled through a heat exchanger or the PFC fluid itself can be used in a refrigeration cycle. This is where the PFC solution is compressed, passed through an evaporator and a heat exchanger, primarily used to cool the cell. It is widely known that fuel cells lose efficiency when they get too hot. So the larger the fuel cell system, the more heat generated, which can lead to increased efficiency losses. Cooling the PFC solution can eliminate such losses. The PFC solution of this invention, when used with fuel cells, can be static or can be circulated in a closed system, were hydrogen is injected in line. This provides for a safer process as the hydrogen gas in diffused directly within the liquid.

In an alternate embodiment of this invention, to store hydrogen within a pressure vessel, a solid PFC solution was created to provide a solid state hydrogen storage system device, where the PFC solid solution is mixed with nano porous scaffolding materials. This invention utilizes a relatively low molecular weight solid PFC, such as but not limited to C4Cl4F4, with a 0% to 99% mixture of nano porous scaffolding material. The mixture used is 75% Graphene Oxide to the solid PFC used, but one skilled in the art will realize that other percentages may yield better desired results. A solid state hydrogen storage device can be created using solid PFCs, with nano confinement, comprising of a nano porous scaffold within the PFC solution, such that the scaffolding materials that can be chosen are, but are not limited to, metallic scaffolds, Silicon aero gels, organic frameworks, mesoporous frameworks like MCM-41, metal hydrides, carbon derivatives, like fullerenes, nano tubes, Graphene, Graphene oxides.

In another embodiment, this invention utilizes nano porous confined scaffolding material within a relatively low molecular weight liquid PFC solution, to store hydrogen under pressure. Scaffolding materials that can be used are, but not limited to, are metallic scaffolds, Silicon aero gels, organic frameworks, mesoporous frameworks like MCM-41, metal hydrides, carbon derivatives, like fullerenes, nano tubes, Graphene, Graphene oxides.

One of the fluorocarbons anticipated for this invention was Perfluorohexane (C6F14), a linear branched derivative of hexane. This PFC was determined to be subpar in ability to store the levels desired of hydrogen at STP. However, because of this finding, it was determined that by using PFCs that are relatively low in molecular weight compared to Perfluoroheaxane, with a low carbon to fluoride ratio performed at the levels of hydrogen absorption desired. Desirable fluorocarbons used for this invention, but not limited to, are C6F6, C2F2CL3, C₄Cl₂F₆, C4CL4F4.

C4Cl4F4 is known to be at a solid at room temperature, but its properties can be changed, such a mixture of 20% C2F2CL3 with C4Cl4F4, created a liquid PFC, with high hydrogen absorption characteristics. One skilled in the art will recognize that there are many different combinations of a PFC solutions that can be mixed, that could be used to achieve desired states; liquid or solid, melting temperature, density and absorption characteristics.

In some embodiments, using a liquid medium to store hydrogen in a pressure vessel with a nano porous confined scaffold is anticipated. However, there are known challenges to this, such as the PFC solution leaking to the atmosphere. This can be overcome within this invention with a sieve in line that only lets hydrogen out of the system, which is selective only to the hydrogen and not the PFC solution. This can also be achieved by using rare metal groups, such as palladium in line as hydrogen diffuses through the material.

This invention also anticipates a solid state, highly nano porous structure, using a solid PFC, with a nano porous matrix, to store the hydrogen at pressure in a pressure vessel. The scaffold anticipated is carbon derivatives. However, metallic scaffolds, Silicon aero gels, organic frameworks, mesoporous frameworks like MCM-41, metal hydrides, nanoporous alumina , fullerenes, nano tubes, Graphene, Graphene oxides, or a mixture of these materials can also be used, to achieve desired results. This solid state design eliminates any possibility for PFC greenhouse gases to escape to the atmosphere. When preparing a solid PFC solution, the nano porous scaffold material is added when the PFC solid is melted in a liquid state. This mixture can be poured into a pressure vessel. The solution is maintained or reheated to keep it in such a liquid state, while hydrogen is added under pressure. Once that occurs, the system is allowed to cool and mold to the pressure vessel interior. This process creates vacancies in the solid PFC matrix for better hydrogen absorption.

Carbon based scaffolding is desirable in this invention. The carbon scaffolding material can be coated with rare metal groups, like platinum or palladium, to take advantage of phenomena called adsorption on the face of the scaffold. With the rare metals acting as a catalyst, hydrogen atoms split off to adsorb to its surface, and diffuse through to the carbon substrate, where they bond. Hydrogen molecules are broken down into hydrogen atoms by the catalyst. They bind to the face of the material with much less energy due to the catalyst present. This technique can be applied to the other scaffolds mentioned as well, to coat them with a rare metal catalyst to induce adsorption, such as, on highly porous silica aero gels. It is also conceivable that a carbon coating can be applied to a non carbon based scaffolds, and then apply a metal catalyst coating. For instance, but not limited to silica aero gels, to be coated with a graphene monolayer by chemical vapor deposition (CVD), then coated with a rare nano metal catalyst such as but not limited to platinum or palladium, by CVD.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

It will be appreciated by those skilled in the art that many modifications and variations may be made to the methods of the invention described herein without departing from the spirit and scope of the invention.

What is claimed is:

1. A solution for storing hydrogen or hydrocarbon based gases able to power combustion and or fuel cell systems, comprising of
a relatively low molecular weight perfluorocarbon (PFC) solution wherein the PFC solution is in a solid or liquid state, with a relative low fluoride to carbon bond ratio, which is used to store hydrogen or other hydrocarbon based gases at standard temperature and pressure (STP) and or above STP.

2. The solution to claim 1, where a highly nano porous scaffolding material is used within the PFC solution.

3. The solution to claim 1, wherein hydrogen is bubbled or diffused directly in the solution or injected through a line to charge the PFC solution in a closed system.

4. The solution of claim 3, where the solution can be static, or circulated alone, or circulated and passed through a heat exchanger.

5. The solution of claim 3, where a refrigeration cycle can be maintained with a compressor, an evaporator and a heat exchanger.

6. The solution of claim 1, wherein the solution can be stored in a pressure vessel.

7. The solution of claim 6, where a porous sieve or rare metal can be used on an exterior line to exclude liquid PFCs from entering the atmosphere.

8. The solution of claim 2, where the nano porous scaffolding materials are used within the PFC solution, to include all materials and mixtures, not just limited to carbon with all of its derivatives, nano porous alumina, metal and its hydrides ,organic frameworks, mesoporous frameworks like MCM-41, Silica and its aero gels.

9. The solution of claim 2 wherein the ratio of the nano porous scaffolding material used in the PFC is 0% to 99%.

10. The solution of claim 8, wherein nano metallic catalysts can be deposited on the surface of the nano porous scaffolds to induce hydrogen adsorption or can be deposited or added to the entire composite solution if desired.

11. The solution to claim 8, wherein nano carbon derivatives can be deposited on the scaffolding material by chemical vapor deposition.

12. The solution of claim 1 wherein the PFC solution can be mixed or altered to obtain certain desired absorption characteristics.

13. The method of preparing a solid state PFC for hydrogen storage comprising:
heating a solid PFC solution to its liquid form;
adding the desired amount of nano porous scaffold material;
pouring the liquid PFC solution and nano porous scaffold material into a pressure vessel wherein hydrogen can be added under pressure while the PFC solution is still in its liquid state; and
cooling the PFC solution back to a solid state.

14. The method of claim 11 wherein the PFC solution can be altered using nano metallic catalyst deposition to obtain certain desired adsorption characteristics.
